(19) United States
(12) Patent Application Publication
(10) Pub. No.: US 2025/0142517 A1
(43) Pub. Date: May 1, 2025

(54) METHODS AND APPARATUSES FOR MEASUREMENT CALIBRATION INDICATOR REPORTING

(71) Applicant: Nokia Technologies Oy, Espoo (FI)

(72) Inventors: Hyun-Su CHA, Naperville, IL (US); Ryan KEATING, Naperville, IL (US)

(21) Appl. No.: 18/835,333

(22) PCT Filed: Dec. 22, 2022
(86) PCT No.: PCT/EP2022/087390

§ 371 Date: Aug. 1, 2024

Related U.S. Application Data
(60) Provisional application No. 63/306,766, filed on Feb. 4, 2022.

(51) Int. Cl. H04W 64/00; H04L 5/00

(52) U.S. Cl. CPC H04W 64/00; H04L 5/0051

(57) ABSTRACT

Systems, methods, apparatuses, and computer program products for positioning measurement calibration are provided. One method may include obtaining calibration information of a positioning measurement, and transmitting the positioning measurement and the calibration information to a network node. The calibration information may include an indication of whether the positioning measurement is calibrated.

### TECHNICAL FIELD

Some example embodiments may generally relate to communications including mobile or wireless telecommunication systems, such as Long Term Evolution (LTE) or fifth generation (5G) radio access technology or new radio (NR) access technology or 5G beyond, or other communications systems. For example, certain example embodiments may generally relate to systems and/or methods for positioning measurement calibration.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology and/or 5G beyond. 5G wireless systems refer to the next generation (NG) of radio systems and network architecture. A 5G system is mostly built on a 5G new radio (NR), but a 5G (or NG) network can also build on the E-UTRA radio.

It is estimated that NR provides bitrates on the order of 10 to 20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT).

With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses.

It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio. 5G beyond is expected to support further use cases beyond current mobile use scenarios, such as virtual and augmented reality, artificial intelligence, instant communications, improved support of IoT, etc.

### SUMMARY

An embodiment may be directed to an apparatus including at least one processor and at least one transceiver. The at least one processor may be configured to obtain calibration information of a positioning measurement. The at least one transceiver may be configured to transmit the positioning measurement and the calibration information to a network node, where the calibration information comprises an indication of whether the positioning measurement was calibrated.

An embodiment may be directed to an apparatus including at least one processor and at least one transceiver. The at least one transceiver may be configured to receive, from a user equipment or network node, at least one positioning measurement and calibration information for the at least one positioning measurement. The calibration information comprises an indication of whether the at least one positioning measurement was calibrated. The at least one processor may be configured to, depending on the calibration information, determine whether calibration needs to be performed for the at least one positioning measurement.

An embodiment may be directed to an apparatus including at least one processor and at least one memory comprising computer program code. The at least one memory and computer program code may be configured, with the at least one processor, to cause the apparatus at least to obtain calibration information of a positioning measurement, and to transmit the positioning measurement and the calibration information to a network node. The calibration information may include an indication of whether the positioning measurement was calibrated.

An embodiment may be directed to an apparatus including at least one processor and at least one memory comprising computer program code. The at least one memory and computer program code may be configured, with the at least one processor, to cause the apparatus at least to receive, from a user equipment or network node, at least one positioning measurement and calibration information for the at least one positioning measurement. The calibration information may include an indication of whether the at least one positioning measurement was calibrated. The at least one memory and computer program code may be configured, with the at least one processor, to cause the apparatus at least to, depending on the calibration information, determine whether calibration needs to be performed for the at least one positioning measurement.

An embodiment may be directed to a method including obtaining calibration information of a positioning measurement, and transmitting, by a user equipment or network node, the positioning measurement and the calibration information to another network node. The calibration information may include an indication of whether the positioning measurement was calibrated.

An embodiment may be directed to a method including receiving, from a user equipment or network node, at least one positioning measurement and calibration information for the at least one positioning measurement. The calibration information may include an indication of whether the at least one positioning measurement was calibrated. The method may also include, depending on the calibration information, determining whether calibration needs to be performed for the at least one positioning measurement.

An embodiment may be directed to an apparatus including means for obtaining calibration information of a positioning measurement, and means for transmitting the positioning measurement and the calibration information to a network node. The calibration information may include an indication of whether the positioning measurement was calibrated.

An embodiment may be directed to an apparatus including means for receiving, from a user equipment or network node, at least one positioning measurement and calibration information for the at least one positioning measurement. The calibration information may include an indication of whether the at least one positioning measurement was calibrated. The apparatus may also include means for determining, depending on the calibration information, whether calibration needs to be performed for the at least one positioning measurement.

An embodiment may be directed to a computer readable medium comprising program instructions stored thereon for performing at least the following: obtaining calibration information of a positioning measurement, and transmitting the positioning measurement and the calibration information to another network node. The calibration information may include an indication of whether the positioning measurement was calibrated.

An embodiment may be directed to a computer readable medium comprising program instructions stored thereon for performing at least the following: receiving, from a user equipment or network node, at least one positioning measurement and calibration information for the at least one positioning measurement. The calibration information may include an indication of whether the at least one positioning measurement was calibrated. The program instructions stored on the computer readable medium may also perform: depending on the calibration information, determining whether calibration needs to be performed for the at least one positioning measurement.

Thus, certain example embodiments may provide at least systems, methods, and/or apparatuses for improved positioning measurement calibration. As a result, example embodiments can provide technical advantages including, but not limited to, improved accuracy, such as positioning measurement accuracy. In addition, some example embodiments can provide improved network efficiency, for example by reducing signaling, latency and/or power consumption. Accordingly, the use of certain example embodiments results in improved functioning of communications networks and their nodes.

### BRIEF DESCRIPTION OF THE DRAWINGS

For proper understanding of example embodiments, reference should be made to the accompanying drawings, wherein:

FIG. 1 illustrates an example signaling diagram, according to an embodiment;

FIG. 2 illustrates an example flow diagram of a method, according to an embodiment;

FIG. 3 illustrates an example flow diagram of a method, according to an embodiment; and

FIG. 4 illustrates an example of a system including multiple apparatuses, according to certain embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for measurement calibration indicator reporting, e.g., considering timing error group information, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Third Generation Partnership Project (3GPP) Release-16 includes native positioning support in NR. As In particular, the following positioning solutions are specified for NR Release-16: Downlink Time Difference of Arrival (DL-TDOA), Uplink Time Difference of Arrival (UL-TDOA), Downlink Angle of Departure (DL-AoD), Uplink Angle of Arrival (UL-AoA), and Multi-cell Round Trip Time (Multi-RTT).

In Relese-16, a UE is expected to be configured with measurement gaps (MG) when performing positioning measurements. In Release-17, 3GPP started NR positioning enhancement work, for example focusing on increasing accuracy, reducing latency and increasing efficiency (low complexity; low power consumption; low overhead) based on Release-16 solutions.

Methods, measurements, signalling, and procedures are being considered for improving positioning accuracy of the Release-16 NR positioning methods by mitigating user device receiver (Rx)/transmitter (Tx) and/or gNB Rx/Tx timing delays. These may include DL, UL and DL+UL positioning methods, as well as UE-based and UE-assisted positioning solutions. It is noted that a user device in this disclosure may also be called user equipment (UE).

Timing error may be defined by group delay and the concept of timing error group (TEG) may be defined as discussed in the following.

From a signal transmission perspective, there may be a time delay from the time when the digital signal is generated at baseband to the time when the radio frequency (RF) signal is transmitted from the Tx antenna. For supporting positioning, the UE or transmission reception point (TRP) may an internal implement calibration/compensation of the Tx time delay for the transmission of the DL positioning reference signals (PRS)/UL sounding reference signals (SRS), which may also include the calibration/compensation of the relative time delay between different RF chains in the same TRP/UE. The compensation may also consider the offset of the Tx antenna phase center to the physical antenna center. It is note that the calibration may not be perfect. The remaining Tx time delay after the calibration, or the uncalibrated Tx time delay may be defined as Tx timing error.

From a signal reception perspective, there may be a time delay from the time when the RF signal arrives at the Rx antenna to the time when the signal is digitized and time-stamped at the baseband. For supporting positioning, the UE/TRP may implement an internal calibration/compensation of the Rx time delay before it reports the measurements that are obtained from the DL PRS/UL SRS signals, which may also include the calibration/compensation of the relative time delay between different RF chains in the same TRP/UE. The compensation may also consider the offset of the Rx antenna phase center to the physical antenna center. However, as mentioned above, the calibration may not be perfect. The remaining Rx time delay after the calibration or the uncalibrated Rx time delay may be defined as Rx timing error.

A UE Tx TEG may be associated with the transmissions of one or more UL SRS resources for positioning purposes, which have the Tx timing errors within a certain margin. A TRP Tx TEG may be associated with the transmissions of one or more DL PRS resources, which have the Tx timing errors within a certain margin.

A UE Rx TEG may be associated with one or more DL measurements, which have the Rx timing errors within a certain margin. A TRP Rx TEG may be associated with one or more UL measurements, which have the Rx timing errors within a margin.

A UE RxTx TEG may be associated with one or more UE Rx-Tx time difference measurements, and one or more UL SRS resources for positioning purposes, which have the ‘Rx timing errors+Tx timing errors’ within a certain margin. A TRP RxTx TEG may be associated with one or more gNB Rx-Tx time difference measurements and one or more DL PRS resources, which have the ‘Rx timing errors+Tx timing errors’ within a certain margin.

A UE may be able to provide Rx TEG information associated with the reference signal time difference (RSTD) measurement for DL-TDOA, and the TRP may provide association information of PRS resource(s) with a Tx TEG. That is, conceptually, the UE can inform a location management function (LMF) with which RX panel/RF chain is used for the RSTD measurement of a PRS resource and the LMF can know which Tx panel/RF chain of the TRP is used to transmit the PRS resource. For the UL-based positioning, the UE can provide association information of UL SRS resource(s) with Tx TEG information and the TRP can provide association information relative time of arrival (RTOA) measurements with TRP Rx TEG to the LMF.

Regarding providing association information of UL SRS resource(s) with UE Tx TEG, two possible options may be considered. In a first option, subject to a UE's capability, the UE may provide the association information of UL SRS resources for positioning with Tx TEGs directly to the LMF. It may also be possible that the LMF can forward the association information provided by the UE to the serving and neighbouring gNBs.

In a second option, subject to the UE's capability, the UE may provide the association information of UL SRS resources for positioning with Tx TEGs to the serving gNB. The serving gNB may forward the association information provided by the UE to the LMF. It may also be possible that the LMF can forward the association information from the serving gNB for the UE to the neighbouring gNBs.

It is noted that, if the first option is used, then LPP (LTE Positioning Protocol) signaling can be used for the UE Tx TEG reporting. However, if the second option is used, then RRC signaling may be used for the UE Tx TEG reporting.

In Release-17 NR positioning, the UE and TRP can report multiple measurements in a single reporting. For instance, the UE may report positioning measurements as a set, such as (RSTD, DL RSRP, UE Rx-Tx time difference). Similarly, the TRP may report positioning measurements as a set, such as (RTOA, UL RSRP, gNB Rx-Tx time difference). This may be referred to as batch reporting.

Furthermore, a LMF can request UE to measure RSTD with different UE Rx TEGs and/or request UE to measure UE Rx-Tx time difference measurement with different UE RxTx TEGs. Similarly, a LMF can request a TRP to measure RTOA with different gNB Rx TEGs and/or request TRP to measure gNB Rx-Tx time difference measurement with different TRP RxTx TEGs.

Thus, as outlined above, timing error mitigation for improvement of accuracy of the timing measurement is being contemplated. For both of the UE and the TRP, the concept of Tx TEG, Rx TEG, RxTx TEG has been introduced as discussed above. In consideration of the UE and TRP, there are six TEGs as follows: UE Tx TEG, UE Rx TEG, UE RxTx TEG, TRP Tx TEG, TRP Rx TEG, and TRP RxTx TEG.

Regarding other TEG information, consideration is being given to the association between TEG and reference signal resource and the association between different type of TEGs (e.g., Tx TEG and RxTx TEG). For example, in the case of UE Tx TEG, the UE Tx TEG ID can be associated with SRS resource(s) so the UE needs to determine association between a specific Tx TEG and SRS resource(s). In addition, the Tx TEG can also be associated with a specific RxTx TEG and, therefore, there may be association between SRS resource(s), a Tx TEG and a RxTx TEG. Furthermore, periodic reporting, semi-persistent reporting and/or event-triggered based reporting of the association information are being contemplated.

However, one of the potential issues may relate to calibration information. In particular, the LMF may not know if the provided measurements have already been calibrated or not. If the UE and/or the gNB calibrated measurements associated with specific TEGs by their implementation before measurement reporting, then the LMF can use the measurements as they are without further calibration considering TEG information associated with the measurements. It is still under consideration on whether and/or how to use reference devices, where the location of the reference devices are assumed as known to the LMF. The reference devices could be the UE and/or TRP. If the TRP is used as a reference device, the measurement calibration behavior from the gNB may be expected. However, currently, the LMF is not able to know if the provided measurements have been calibrated or not.

For example, in the case of batch reporting introduced above, both UL-TDOA and multi-RTT are initiated by the LMF, and the gNB will report both RTOA and gNB Rx-Tx time difference measurements to the LMF. For Multi-RTT, the UE may also report UE Rx-Tx time difference measurements. These three measurements (RTOA, gNB Rx-Tx time difference, and UE Rx-Tx time difference) are timing measurements, so they are affected by the UE Tx TEG. The UE may report the association information between Tx TEG and SRS resources to either or both of gNB and LMF. For example, for mitigating UE Tx timing errors when both UL-TDOA and Multi-RTT, or UL-TDOA and DL-TDOA are used, the UE may provide the association information of UL SRS resources for positioning with UE Tx TEGs to the serving gNB if a request to provide the association information is received from the gNB or to the LMF if a request to provide the association information is received from the LMF.

In case of RTOA measurement, the gNB can perform calibration for RTOA measurement obtained from specific SRS resource(s) based on the association information provided by the UE. Also, the LMF may be able to perform RTOA measurement calibration using UE Tx TEG association information.

Similarly, the gNB can calibrate a gNB Rx-Tx time difference measurement using UE Tx TEG information and gNB Rx TEG information, and the LMF is also able to do the calibration.

For this reason, both of the gNB and LMF may perform calibration for RTOA and/or gNB Rx-Tx time difference measurement, or both of the gNB and LMF may not perform calibration for RTOA and/or gNB Rx-Tx time difference measurement.

Similarly, both UE and LMF may perform calibration for RSTD and/or UE Rx-Tx time difference measurement, or both UE and LMF may not perform calibration. Double calibration can be expected for the measurement for the former case and no calibration for the second case, and both may result in measurement errors. Certain embodiments discussed herein may address and solve at least these problems.

Currently, it might be unclear how a UE and/or TRP could calibrate the timing errors considering specific TEG. Some embodiments may consider at least two possible methods for the calibration of timing errors, as discussed in the following.

A first method may include reference device(s), such as UE/TRP or other type of devices, being used to estimate timing errors for a specific TEG and/or timing error difference between two different TEGs, where a single TEG could also be associated with a time error generated from a RF chain. The reference device may be able to provide the UE/gNB of the estimated timing error difference information between different TEGs. If the reference device is one of the TRPs, the gNB may easily obtain the information.

Additionally, the timing error information can be forwarded to the UE from the gNB. If a reference device supports sidelink functionality, then signalling on the timing errors for the TEG may be performed by using sidelink to the target UEs. It should be noted that depending on the definition of TEG, timing error for a single TEG can be defined as timing error difference, such as between different RFs/panels.

A second method may consider devices that have self-calibration functionality and/or capability. For instance, self-calibration of the UE side may be used to mitigate timing errors considering TEG. For example, the UE can estimate timing error for a specific Rx TEG and Tx TEG of itself. Then, the UE can calibrate sum of Tx timing error and Rx timing error for the Rx TEG and Tx TEG.

Certain example embodiments provide a method for UE and/or network node (e.g., gNB) to inform a LMF whether the network (gNB) positioning measurements, such as RTOA and/or gNB Rx-Tx time difference, have been calibrated or not using UE Tx TEG.

According to an embodiment, a network node, such as a LMF and/or gNB may configure the UE with UL and DL reference signals. In one embodiment, the gNB may configure the UE with positioning SRS resources, and the UE may associate the SRS resources with UE Tx TEGs. In some embodiments, the gNB may determine TRP Tx TEG association information with DL PRS resources.

In certain embodiments, the UE may report calibrated measurements without an indication or request by the LMF. According to a further embodiment, however, the LMF may request and/or indicate to the UE to report calibrated measurements for specific RS resource(s) considering the association between specific TEG(s) and RS resource(s). For example, the LMF may request and/or indicate to the UE to report calibrated timing measurement(s) considering specific UE Rx TEG(s), UE Tx TEG(s), and/or UE RxTx TEG(s).

A first option may include the UE providing an indicator for a specific measurement. According to this option, the UE may report measurement(s) and an indicator that implies whether the measurement has been calibrated or not.

For instance, for DL-TDOA, the UE may report the indicator informing if the RSTD measurement(s) has been calibrated for specific UE Rx TEG(s). Timing error for a UE Rx TEG can be defined as a timing error difference between timing errors generated from different RFs/panels, or timing error for a UE Rx TEG can be defined as a timing error generated from a RF/panel. In the latter case, the UE may be able to calibrate timing error difference between two different UE Rx TEGs.

In one embodiment, the UE can report a specific TEG which was used as baseline TEG. For example, if the UE uses Rx TEG1 as the baseline then all reported RSTD(s) should have the same Rx timing error, which is the one associated with Rx TEG 1. As an example, if a measurement is indicated as calibrated and then a baseline TEG is shared it means the measurement has just the timing errors remaining from the baseline TEG. For Multi-RTT, the UE may report the indicator informing if the UE Rx-Tx measurement(s) has been calibrated for specific UE RxTx TEG(s).

A second option may include the UE providing an indicator for a specific TEG. In this embodiment, the UE may inform the LMF that it will report the calibrated measurements for specific TEG(s). The UE may perform calibration behavior before reporting every timing measurement for specific TEG(s). The LMF may expect this UE behavior unless it receives additional notice from the UE.

According to some embodiments, the gNB may report calibrated measurements without indication and/or request by the LMF. In an embodiment, the LMF may request the gNB to report calibrated measurements for specific RS resource(s) considering the association between specific TEG(s) and RS resource(s). The LMF may request the gNB to report calibrated timing measurement(s) considering specific TRP Rx TEG(s), TRP Tx TEG(s), and/or TRP RxTx TEG(s). In addition, the gNB can calibrate the measurement for specific UE Tx TEG(s).

A first option may include the gNB providing an indicator for a specific measurement. In this embodiment, the gNB may report measurement(s) and an associated indicator that implies whether the measurement has been calibrated or not. For instance, for UL-TDOA, the gNB may report the indicator informing if the RTOA measurement(s) has been calibrated for specific TRP Rx TEG(s). For Multi-RTT, the gNB may report the indicator informing whether the gNB Rx-Tx measurement has been calibrated for specific TRP RxTx TEG(s).

A second option may include the gNB providing an indicator for a specific TEG. In this embodiment, the gNB may inform the LMF that it will report the calibrated measurements for specific TEG(s). The gNB may perform calibration behavior before reporting every time measurement for specific TEG(s). The LMF may expect this gNB behavior unless additional notice.

In some embodiments, the LMF behavior can be different depending on the indicator from gNB and UE. For example, depending on the reported indicator, the LMF may determine for which TEG the effects of timing errors need to be corrected for a particular measurement. According to certain embodiments, the LMF may continue processing to estimate the location of the UE.

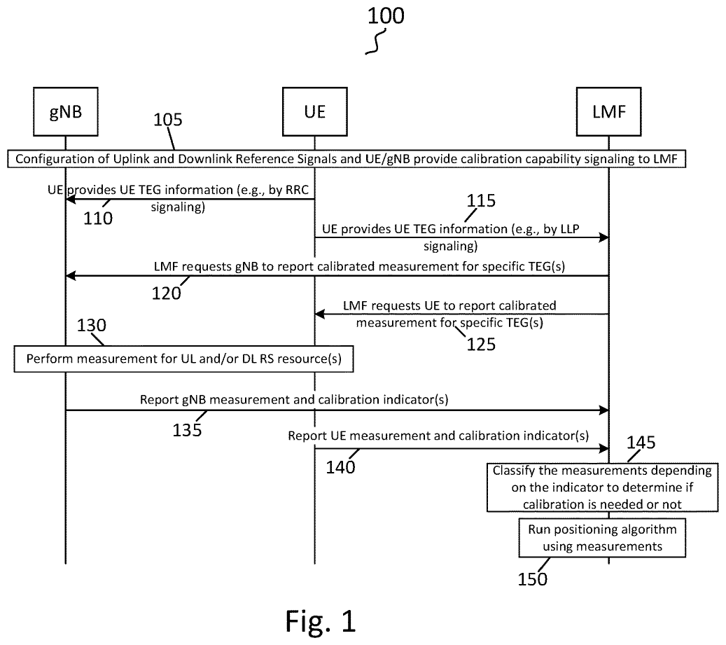

FIG. 1 illustrates an example signaling diagram 100 depicting a procedure for measurement calibration indicator reporting, according to an example embodiment. As illustrated in the example of FIG. 1, the signaling may involve one or more of a gNB, UE, and/or LMF.

As depicted in the example of FIG. 1, at 105, the LMF and/or gNB may configure the UE with uplink (UL) and downlink (DL) reference signals. The gNB may configure the UE with positioning SRS resources, and the UE may associate the SRS resources with UE Tx TEGs and/or UE RxTx TEG(s). The gNB may determine association of TRP Tx TEG(s) and/or TRP RxTx TEG(s) to the DL PRS resources.

In an embodiment, the gNB may provide TRP Tx TEG association information to the UE by RRC. This information can be used by the UE to estimate timing error of TRP Tx TEGs.

As further illustrated in the example of FIG. 1, at 110, the UE may report Tx TEG association information to the gNB, for example, by a new RRC message and, at 115, the UE may also provide the association information of UE Tx TEG(s) and/or UE RxTx TEG(s) to the LMF, for example, by LPP signaling.

In some embodiments, the UE may report calibrated measurements without indication and/or request by the LMF.

However, according to a further embodiment, as illustrated at 125, the LMF may request or indicate to the UE to report calibrated measurements for specific RS resource(s) considering the association between specific TEG(s) and RS resource(s). For example, the LMF may request or indicate UE to report calibrated timing measurement(s) considering specific UE Rx TEG(s), UE Tx TEG(s), and/or UE RxTx TEG(s).

According to some embodiments, the UE may, at 130, perform measurements for UL and/or DL RS resource(s) and, at 140, the UE may report UE measurement and calibration indicator(s) to the LMF. In one option, the UE may report, at 140, the measurement and an indicator that implies whether the measurement has been calibrated or not.

For example, for DL-TDOA, the UE may report the indicator informing if the RSTD measurement(s) has been calibrated for specific UE Rx TEG(s), may report the indicator informing if the RSTD measurement(s) has been calibrated for specific TRP Tx TEG(s), and/or may report the indicator informing if the RSTD measurement(s) has been calibrated for specific UE Rx TEG(s) and TRP Tx TEG(s). In case the UE calibrates measurement considering the TRP TEG information, the UE may report to the gNB that it calibrates specific measurement considering TRP TEG information. This can help the gNB to decide whether or not to calibrate measurement obtained from TRP(s) considering specific TRP Tx TEG(s) of the TRP(s).

In certain embodiments, for Multi-RTT, the UE may report the indicator informing if the UE Rx-Tx measurement(s) has been calibrated for specific UE RxTx TEG(s), may report the indicator informing if the UE Rx-Tx measurement(s) has been calibrated for specific UE Rx TEG, may report the indicator informing if the UE Rx-Tx measurement(s) has been calibrated for specific UE Tx TEG, and/or may report the indicator informing if the UE Rx-Tx measurement(s) has been calibrated for specific UE Rx TEG and UE Tx TEG.

According to some embodiments, the UE may be additionally able to calibrate measurement considering specific TRP Tx TEG and/or TRP Rx TEG. In this case, The UE may report to the gNB that it calibrates specific measurement considering TRP TEG information. This can help the gNB to decide whether to calibrate measurement obtained from TRP(s) considering TRP Tx TEG and/or TRP Rx TEG.

In an another option, the UE may inform, at 140, the LMF that it will report the calibrated measurements for specific TEG(s). According to this example, the UE may perform calibration behavior before reporting every timing measurement for specific TEG(s). In an embodiment, the LMF may expect this UE behavior unless additional notice from the UE.

In some embodiments, the gNB may report calibrated measurements without indication and/or request by the LMF. However, in a further embodiment, the LMF may request, at 120, the gNB to report calibrated measurements for specific RS resource(s) considering the association between specific TEG(s) and RS resource(s). For example, the LMF may request the gNB to report calibrated timing measurement(s) considering specific TRP Rx TEG(s), TRP Tx TEG(s), and/or TRP RxTx TEG(s). In addition, the gNB can calibrate the measurement for specific UE Tx TEG(s).

According to some embodiments, the gNB may, at 130, perform measurements for UL and/or DL RS resource(s) and, at 135, the gNB may report gNB measurement and calibration indicator(s) to the LMF. In one option, the gNB may report, at 135, measurement and an associated indicator that implies whether the measurement has been calibrated or not.

For example, for UL-TDOA, the gNB may report the indicator informing if the RTOA measurement has been calibrated for a specific TRP Rx TEG, may report the indicator informing if the RTOA measurement has been calibrated for a specific UE Tx TEG, and/or may report the indicator informing if the RTOA measurement(s) has been calibrated for both of the TRP Rx TEG and UE Tx TEG. In the case that the gNB calibrates measurement considering the UE TEG information, the gNB may inform the UE that it calibrates specific measurement considering TEG information from UE. This can help the UE to decide whether or not to adjust transmission timing considering TEG information.

In certain embodiments, for Multi-RTT, the gNB may report the indicator informing if the gNB Rx-Tx measurement has been calibrated for specific TRP RxTx TEG(s), may report the indicator informing if the gNB Rx-Tx measurement has been calibrated for specific TRP Rx TEG, may report the indicator informing if the gNB Rx-Tx measurement has been calibrated for specific TRP Tx TEG, and/or may report the indicator informing if the gNB Rx-Tx measurement has been calibrated for specific TRP Rx TEG and TRP Tx TEG. The gNB can additionally calibrate measurement considering specific UE Tx TEG and/or UE Rx TEG.

According to an embodiment, the gNB may inform the UE that it calibrates specific measurement considering TEG information from UE. This can help the UE to decide whether or not to calibrate measurement.

According to another option, the gNB may inform the LMF, at 135, that the gNB will report the calibrated measurements for specific TEG(s). The gNB may perform calibration behavior before reporting every timing measurement for specific TEG(s). The LMF may expect this gNB behavior unless additional notice.

According to certain embodiments, the LMF behavior may vary depending on the indicator received from the gNB and/or UE. As illustrated in the example of FIG. 1, at 145, depending on the reported indicator, the LMF can determine, for which TEG, the effects of timing errors need to be corrected or calibrated for a particular measurement.

As an example for purposes of illustration, if the indicator is binary, the UE/TRP may simply indicate if the reported measurement was calibrated or not. If a reported measurement from the gNB/UE was not calibrated, then the LMF may calibrate the measurement.

However, if a reported measurement from the gNB/UE was calibrated, then the LMF may not calibrate the measurement. The LMF may then continue processing to estimate the location of UE. For example, as shown at 150, the LMF may run a positioning algorithm using the measurements.

For purpose of the calibration, timing error information for a specific TEG may need to be available for the UE/TRP/LMF. For example, a reference device may be able to provide the timing error information for a specific UE and/or TRP Tx TEG, where the reference device is a UE and/or TRP whose location is known to the LMF. If there is no synchronization error between the reference device and TRP and if the Rx group delay of the reference device could be nearly and completely compensated, the reference device can extract TRP Tx timing error from propagation delay.

As another approach, the advanced device may be able to estimate its own timing error. For instance, the gNB and/or UE may measure Rx plus Tx group delay for each RF chain. In this case, the gNB and/or UE could calibrate UE Rx-Tx measurement using the group delay measurement information.

In one embodiment, if the UE and/or TRP may be able to estimate the actual Tx/Rx timing error associated with a TEG then when it indicates that a particular measurement is calibrated it is informing the LMF of this fact by not including a baseline TEG. The LMF then knows not to additionally calibrate the measurement further and therefore avoids adding additional errors.

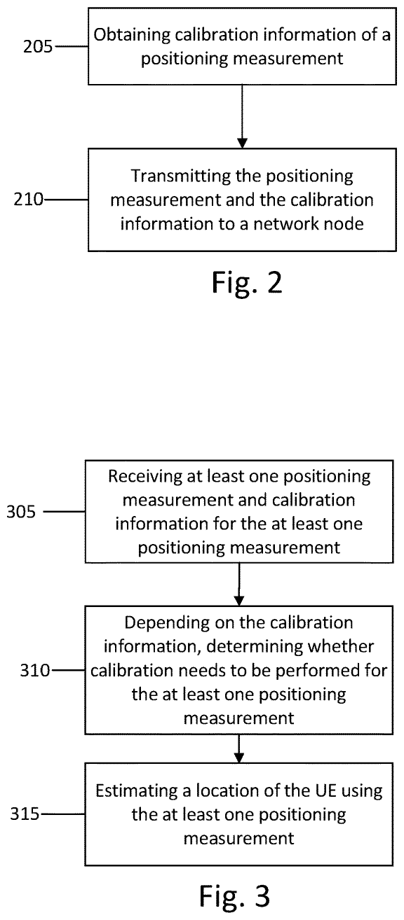

FIG. 2 illustrates an example flow diagram of a method for positioning calibration, according to an example embodiment. For instance, FIG. 2 may illustrate an example method of indicating measurement calibration, e.g., considering timing error group information.

In certain example embodiments, the flow diagram of FIG. 2 may be performed by a network entity or communication device in a communications system such as, but not limited to, LTE, 5G NR, or 5G beyond. For instance, in some example embodiments, the communication device performing the method of FIG. 2 may include a UE, sidelink (SL) UE, wireless device, mobile station, IoT device, UE type of roadside unit (RSU), a wireless transmit/receive unit, customer premises equipment (CPE), other mobile or stationary device, or the like.

For instance, in certain example embodiments, the method of FIG. 2 may include procedures or operations performed by the UE, as described or illustrated elsewhere herein, such as in FIG. 1.

In further example embodiments, network entity performing the flow diagram of FIG. 2 (and operations discussed below) may include or be included in one or more of a base station, access node, node B, eNB, gNB, gNB-DU, gNB-CU, NG-RAN node, 5G node, transmission-reception points (TRPs), high altitude platform stations (HAPS), and/or relay station, or the like.

For instance, in some embodiments, the method of FIG. 2 may include procedures or operations performed by a gNB, as described or illustrated elsewhere herein, such as in FIG. 1.

As illustrated in the example of FIG. 2, the method may include, at 205, obtaining calibration information of a positioning measurement. For example, the positioning measurement may include one or more of relative time of arrival (RTOA) and/or receive (Rx)-transmit (Tx) time difference.

In some embodiments, the method may include performing the positioning measurement for at least one of uplink and/or downlink reference signal resources. According to an embodiment, the method may include, at 210, transmitting the positioning measurement and the calibration information to a network node, such as a LMF.

In certain embodiments, the calibration information may include an indication of whether the positioning measurement was calibrated. In some embodiments, the indication may include an indication of whether the reference signal time difference (RSTD) measurement for downlink (DL) time difference of arrival (TDOA) has been calibrated for at least one of a specific UE receive (Rx) timing error group (TEG) or a specific TRP transmit (Tx) timing error group (TEG).

According to an embodiment, the indication may include an indication of a specific timing error group (TEG) that was used as a baseline timing error group (TEG).

In an embodiment, the indication may include an indication of whether one or more receive-transmit (Rx-Tx) time difference measurements for multi-cell round trip time (multi-RTT) have been calibrated for specific receive-transmit (RxTx) timing error groups (TEGs). According to certain embodiments, the indication may include an indication that the calibrated measurements will be reported for specific timing error groups (TEGs).

According to some embodiments, based on the indication, the method may include receiving a request, from the network node, to report the positioning measurement with calibration. In an embodiment, the request may include a request for calibrated measurements for one or more UL and/or DL reference signal resources considering an association between specific timing error groups (TEGs) and the reference signal resources.

FIG. 3 illustrates an example flow diagram of a method for positioning calibration, according to an example embodiment. For instance, FIG. 3 may illustrate an example method of indicating measurement calibration, e.g., considering timing error group information.

In certain example embodiments, the flow diagram of FIG. 3 may be performed by a network entity or communication device in a communications system such as, but not limited to, LTE, 5G NR, or 5G beyond. For instance, in some example embodiments, the device performing the method of FIG. 3 may include a location management entity or LMF. For instance, in some embodiments, the method of FIG. 3 may include procedures or operations performed by a LMF, as described or illustrated elsewhere herein, such as in FIG. 1.

As illustrated in the example of FIG. 3, the method may include, at 305, receiving, from a UE or network node (e.g., gNB), at least one positioning measurement and calibration information for the at least one positioning measurement. In an embodiment, the calibration information may include an indication of whether the at least one positioning measurement was calibrated.

Depending on the calibration information, the method may include, at 310, determining whether calibration needs to be performed for the at least one positioning measurement. For example, when the calibration information indicates that the at least one positioning measurement is not calibrated, the determining 310 may include determining that the calibration needs to be performed for the at least one positioning measurement.

When the calibration information indicates that the at least one positioning measurement is calibrated, the determining 310 may include determining that the calibration does not need to be performed for the at least one positioning measurement.

In some embodiments, the indication may include an indication of whether the reference signal time difference (RSTD) measurement for downlink (DL) time difference of arrival (TDOA) has been calibrated for at least one of a specific receive (Rx) timing error group (TEG) of UE or a specific transmit (Tx) timing error group (TEG) of TRP.

According to an embodiment, the indication may include an indication of a specific timing error group (TEG) that was used as a baseline timing error group (TEG). In an embodiment, the indication may include an indication of whether one or more receive-transmit (Rx-Tx) time difference measurements for multi-cell round trip time (multi-RTT) have been calibrated for specific receive-transmit (RxTx) timing error groups (TEGs). According to certain embodiments, the indication may include an indication that the calibrated measurements will be reported for specific timing error groups (TEGs).

According to certain embodiments, the method may include, based on the indication, transmitting a request, to the UE or the network node, to report the positioning measurement with calibration. According to an embodiment, the request may include a request for calibrated measurements for one or more UL and/or DL reference signal resources considering an association between specific timing error groups and the reference signal resources. As further illustrated in the example of FIG. 3, the method may include, at 315, estimating a location of the UE using the at least one positioning measurement.

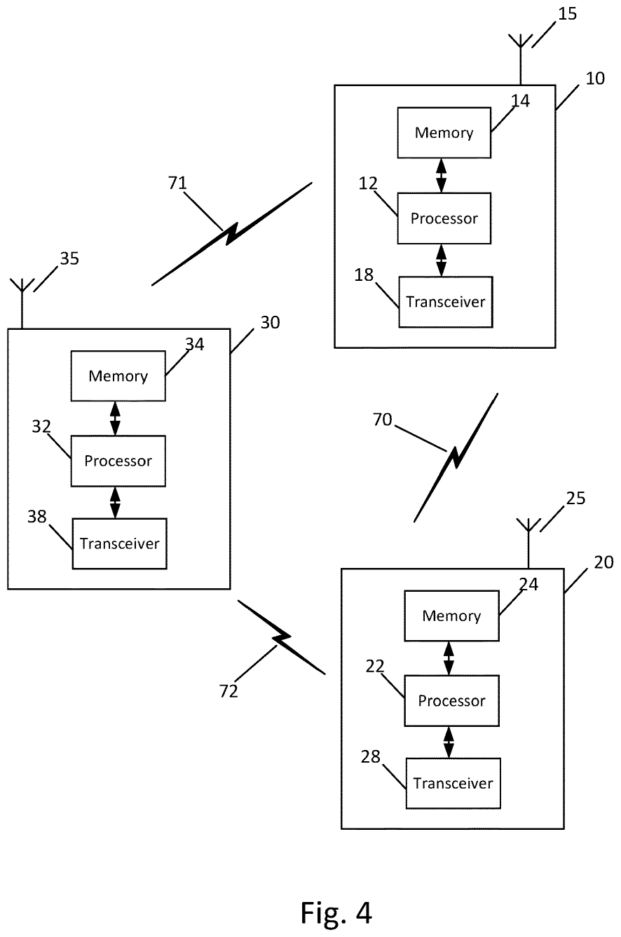

FIG. 4 illustrates an example of an apparatus 10, apparatus 20, and apparatus 30, according to certain example embodiments. In an embodiment, apparatus 10 may be a node, host, or server in a communications network or serving such a network. For example, apparatus 10 may be a UE, mobile equipment (ME), mobile station, mobile device, stationary device, IoT device, TSN device, or other device. As described herein, UE may alternatively be referred to as, for example, a mobile station, mobile equipment, mobile unit, mobile device, user device, subscriber station, wireless terminal, tablet, smart phone, IoT device, sensor or NB-IoT device, or the like. As one example, apparatus 10 may be implemented in, for instance, a wireless handheld device, a wireless plug-in accessory, or the like. It should be noted that one of ordinary skill in the art would understand that apparatus 10 may include components or features not shown in FIG. 4.

As illustrated in the example of FIG. 4, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 4, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources. In certain examples, processor 12 may be configured as a processing means or controlling means for executing any of the procedures described herein.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory.

For example, memory 14 can be comprised of any combination of random access memory (RAM), read only memory (ROM), static storage such as a magnetic or optical disk, hard disk drive (HDD), or any other type of non-transitory machine or computer readable media.

The instructions stored in memory 14 may include program instructions or computer program code that, when executed by processor 12, enable the apparatus 10 to perform tasks as described herein. In certain example embodiments, memory 14 may be configured as a storing means for storing any information or instructions for execution as discussed elsewhere herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information.

The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. In certain example embodiments, transceiver 18 may be configured as a transceiving means for transmitting or receiving information as discussed elsewhere herein. Additionally or alternatively, in some embodiments, apparatus 10 may include an input and/or output device (I/O device) or means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may include a UE (e.g., SL UE), mobile device, mobile station, ME, IoT device and/or NB-IoT device, for example. For example, in some embodiments, apparatus 10 may be configured to perform one or more of the processes depicted in any of the flow charts or signaling diagrams described herein, such as those illustrated in the examples of FIG. 1 and/or FIG. 2.

For instance, in some embodiments, apparatus 10 may be configured to perform one or more of the operations performed by the UE illustrated in FIG. 1. In some embodiments, as discussed herein, apparatus 10 may be configured to perform a procedure relating to positioning measurement calibration, for instance.

According to certain embodiments, apparatus 10 may be controlled by memory 14 and/or processor 12 to obtain calibration information of a positioning measurement, and transceiver 18 may be configured to transmit the positioning measurement and the calibration information to a network node.

In one embodiment, the calibration information may include an indication of whether the positioning measurement was calibrated, as detailed elsewhere herein. According to some embodiments, e.g., based on the indication, transceiver 18 may be configured to receive a request, from the network node, to report the positioning measurement with calibration. In an embodiment, apparatus 10 may be controlled by memory 14 and/or processor 12 to perform the positioning measurement for at least one of UL and/or DL reference signal resources.

FIG. 4 further illustrates an example of an apparatus 20, according to an embodiment. In an embodiment, apparatus 20 may be a node, host, or server in a communications network or serving such a network. For example, apparatus 20 may be a network node, satellite, base station, a Node B, an evolved Node B (eNB), 5G Node B or access point, next generation Node B (NG-NB or gNB), TRP, HAPS, Remote Radio Head (RRH), integrated access and backhaul (IAB) node, and/or a WLAN access point, associated with a radio access network, such as a LTE network, 5G or NR, or 6G. In some example embodiments, apparatus 20 may be gNB or other similar radio node, for instance.

It should be understood that, in some example embodiments, apparatus 20 may be comprised of an edge cloud server as a distributed computing system where the server and the radio node may be stand-alone apparatuses communicating with each other via a radio path or via a wired connection, or they may be located in a same entity communicating via a wired connection.

For instance, in certain example embodiments where apparatus 20 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 20 may include components or features not shown in FIG. 4.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 4.

As illustrated in the example of FIG. 4, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

While a single processor 22 is shown in FIG. 4, multiple processors may be utilized according to other embodiments. For example, it should be understood that, in certain embodiments, apparatus 20 may include more than one processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory.

For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 or apparatus 30 via a wireless or wired communications link or interface 70 according to any radio access technology, such as NR.

According to some embodiments, processor 22 and memory 24 may be included in or may form a part of processing circuitry/means or control circuitry/means. In addition, in some embodiments, transceiver 28 may be included in or may form a part of transceiving circuitry or transceiving means.

As discussed above, according to some embodiments, apparatus 20 may be or may be a part of a network element or RAN node, such as a base station, access point, Node B, eNB, gNB, TRP, RRH, HAPS, IAB node, relay node, WLAN access point, satellite, or the like. According to certain embodiments, apparatus 20 may be controlled by memory 24 and processor 22 to perform the functions associated with example embodiments described herein. For example, in some embodiments, apparatus 20 may be configured to perform one or more of the processes depicted in any of the flow charts or signaling diagrams described herein, such as those illustrated in FIG. 1 or FIG. 2.

In certain embodiments, apparatus 20 may include or represent a network node, such as the gNB illustrated in the example of FIG. 1. According to an embodiment, apparatus 20 may be configured to perform a procedure relating to positioning measurement calibration, for instance.

In certain embodiments, apparatus 20 may be controlled by memory 24 and/or processor 22 to obtain calibration information of a positioning measurement, and transceiver 28 may be configured to transmit the positioning measurement and the calibration information to a network node, such as a LMF. In one embodiment, the calibration information may include an indication of whether the positioning measurement was calibrated, as detailed elsewhere herein.

According to some embodiments, e.g., based on the indication, transceiver 28 may be configured to receive a request, from the network node, to report the positioning measurement with calibration. In an embodiment, apparatus 20 may be controlled by memory 24 and/or processor 22 to perform the positioning measurement for at least one of UL and/or DL reference signal resources.

FIG. 4 further illustrates an example of an apparatus 30, according to an example embodiment. In an example embodiment, apparatus 30 may be a node or element in a communications network or associated with such a network, such as a location management entity or LMF.

In some example embodiments, apparatus 30 may include one or more processors, one or more computer-readable storage medium (for example, memory, storage, or the like), one or more radio access components (for example, a modem, a transceiver, or the like), and/or a user interface. In some example embodiments, apparatus 30 may be configured to operate using one or more radio access technologies, such as GSM, LTE, LTE-A, NR, 5G, WLAN, WiFi, NB-IoT, MulteFire, and/or any other radio access technologies. It should be noted that one of ordinary skill in the art would understand that apparatus 30 may include components or features not shown in FIG. 4.

As illustrated in the example of FIG. 4, apparatus 30 may include or be coupled to a processor 32 for processing information and executing instructions or operations. Processor 32 may be any type of general or specific purpose processor. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 32 is shown in FIG. 4, multiple processors may be utilized according to other example embodiments. For example, it should be understood that, in certain example embodiments, apparatus 30 may include two or more processors that may form a multiprocessor system (e.g., in this case processor 32 may represent a multiprocessor) that may support multiprocessing. In certain example embodiments, the multiprocessor system may be tightly coupled or loosely coupled (e.g., to form a computer cluster).

Processor 32 may perform functions associated with the operation of apparatus 30 including, as some examples, precoding of antenna gain/phase parameters, encoding and decoding of individual bits forming a communication message, formatting of information, and overall control of the apparatus 30, including processes related to management of communication resources.

Apparatus 30 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory.

For example, memory 34 can be comprised of any combination of random access memory (RAM), read only memory (ROM), static storage such as a magnetic or optical disk, hard disk drive (HDD), or any other type of non-transitory machine or computer readable media. The instructions stored in memory 34 may include program instructions or computer program code that, when executed by processor 32, enable the apparatus 30 to perform tasks as described herein.

In an example embodiment, apparatus 30 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 32 and/or apparatus 30.

In some example embodiments, apparatus 30 may also include or be coupled to one or more antennas 35 for receiving a downlink signal and for transmitting via an uplink from apparatus 30. Apparatus 30 may further include a transceiver 38 configured to transmit and receive information. The transceiver 38 may also include a radio interface (e.g., a modem) coupled to the antenna 35. The radio interface may correspond to a plurality of radio access technologies including one or more of GSM, LTE, LTE-A, 5G, NR, WLAN, NB-IoT, BT-LE, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 38 may be configured to modulate information on to a carrier waveform for transmission by the antenna(s) 35 and demodulate information received via the antenna(s) 35 for further processing by other elements of apparatus 30. In other example embodiments, transceiver 38 may be capable of transmitting and receiving signals or data directly. Additionally or alternatively, in some example embodiments, apparatus 30 may include an input and/or output device (I/O device). In certain example embodiments, apparatus 30 may further include a user interface, such as a graphical user interface or touchscreen.

In an example embodiment, memory 34 stores software modules that provide functionality when executed by processor 32. The modules may include, for example, an operating system that provides operating system functionality for apparatus 30. The memory may also store one or more functional modules, such as an application or program, to provide additional functionality for apparatus 30. The components of apparatus 30 may be implemented in hardware, or as any suitable combination of hardware and software. According to an example embodiment, apparatus 30 may optionally be configured to communicate with apparatus 10 via a wireless or wired communications link 71 and/or to communicate with apparatus 20 via a wireless or wired communications link 72, according to any radio access technology, such as NR.

According to some example embodiments, processor 32 and memory 34 may be included in or may form a part of processing circuitry or control circuitry. In addition, in some example embodiments, transceiver 38 may be included in or may form a part of transceiving circuitry.

As discussed above, according to some example embodiments, apparatus 30 may be or may include a location management entity or LMF, for example. According to certain example embodiments, apparatus 30 may be controlled by memory 34 and/or processor 32 to perform the functions associated with example embodiments described herein. For instance, in some example embodiments, apparatus 30 may be configured to perform one or more of the processes depicted in any of the diagrams or signaling flow diagrams described herein, such as the process illustrated in the example of FIG. 1 and/or FIG. 3. As an example, apparatus 30 may correspond to or represent the LMF, such as that illustrated in the example of FIG. 1. According to certain example embodiments, apparatus 30 may be configured to perform a procedure relating to positioning measurement calibration, for instance.

In some embodiments, transceiver 38 may be configured to receive, from a user equipment or network node (e.g., a gNB), at least one positioning measurement and calibration information for the at least one positioning measurement. According to an embodiment, the calibration information may include an indication of whether the at least one positioning measurement was calibrated. In an embodiment, depending on the calibration information, processor 32 may be configured to determine whether calibration needs to be performed for the at least one positioning measurement. According to certain embodiments, processor 32 may be configured to estimate a location of the user equipment using the at least one positioning measurement. In some embodiments, based on the indication, transceiver 38 may be configured to transmit a request, to the user equipment or the network node, to report the positioning measurement with calibration. According to an embodiment, processor 32 may be configured to perform location estimation calculation or computations using reported calibrated measurements from the gNB and/or UE.

In some example embodiments, an apparatus (e.g., apparatus 10 and/or apparatus 20 and/or apparatus 30) may include means for performing one or more methods, processes, and/or procedures, or any of the variants discussed herein. Examples of the means may include one or more processors, memory, controllers, transmitters, receivers, sensors, circuits, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. For example, as discussed in detail above, certain example embodiments can provide systems and/or methods for improved positioning measurement calibration. As a result, example embodiments can improve accuracy, such as positioning measurement accuracy. In addition, some example embodiments can provide improved network efficiency, for example by reducing signaling, latency and/or power consumption. Accordingly, the use of certain example embodiments results in improved functioning of communications networks and their nodes, such as base stations, eNBs, gNBs, and/or IoT devices, UEs or mobile stations, or the like.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, some functionality of example embodiments may be implemented as a signal that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Some embodiments described herein may use the conjunction “and/or”. It should be noted that, when used, the term “and/or” is intended to include either of the alternatives or both of the alternatives, depending on the example embodiment or implementation. In other words, “and/or” can refer to one or the other or both, or any one or more or all, of the things or options in connection with which the conjunction is used.

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### PARTIAL GLOSSARY

LPP LTE Positioning Protocol
LMC Local Location Management Component
LMF Location Management Function
Multi-RTT Multi-cell Round Trip Time
NR New Radio (5G)
NRPPa New Radio Positioning Protocol A
PRS Positioning Reference Signal
RRC Radio Resource Control
RTOA Relative Time of Arrival
Rx-Tx Receive-Transmit
TEG Timing Error Group
TRP Transmission Reception Point
Tx TEG Transmit Timing Error Group
UL-TDOA Uplink Time Difference of Arrival.

1-55. (canceled)

56. An apparatus, comprising:
at least one processor; and
at least one memory including computer program code,
the at least one memory and computer program code configured to, with the at least one processor, cause the apparatus at least to:
obtain calibration information of a positioning measurement; and
transmit the positioning measurement and the calibration information to a network node,
wherein the calibration information comprises an indication of whether the positioning measurement was calibrated.

57. The apparatus of claim 56, wherein the at least one memory and computer program code configured to, with the at least one processor, cause the apparatus at least to:
receive a request, from the network node, to report the positioning measurement with calibration.

58. The apparatus of claim 57, wherein the request comprises a request for calibrated measurements for one or more uplink and/or downlink reference signal resources considering an association between specific timing error groups and the reference signal resources.

59. The apparatus of claim 56, wherein the indication comprises an indication of whether the reference signal time difference measurement for downlink time difference of arrival has been calibrated for at least one of a specific receive timing error group or a specific transmit timing error group.

60. The apparatus of claim 56, wherein the indication comprises an indication of a specific timing error group that was used as a baseline timing error group.

61. The apparatus of claim 56, wherein the indication comprises an indication of whether one or more receive-transmit time difference measurements for multi-cell round trip time have been calibrated for specific receive-transmit timing error groups.

62. The apparatus of claim 56, wherein the indication comprises an indication that the apparatus will report the calibrated measurements for specific timing error groups.

63. The apparatus of claim 56, wherein the network node comprises a location management function, and wherein the apparatus comprises a user equipment or next generation node B (gNB).

64. An apparatus, comprising:
at least one processor; and
at least one memory including computer program code,
the at least one memory and computer program code configured to, with the at least one processor, cause the apparatus at least to:
receive, from a user equipment or network node, at least one positioning measurement and calibration information for the at least one positioning measurement, wherein the calibration information comprises an indication of whether the at least one positioning measurement was calibrated; and
depending on the calibration information, determine whether calibration needs to be performed for the at least one positioning measurement.

65. The apparatus of claim 64, wherein:
when the calibration information indicates that the at least one positioning measurement is not calibrated, the at least one memory and computer program code configured to, with the at least one processor, cause the apparatus at least to determine that the calibration needs to be performed for the at least one positioning measurement, and
when the calibration information indicates that the at least one positioning measurement is calibrated, the at least one memory and computer program code configured to, with the at least one processor, cause the apparatus at least to determine that the calibration does not need to be performed for the at least one positioning measurement.

66. The apparatus of claims 64, wherein the at least one memory and computer program code configured to, with the at least one processor, cause the apparatus at least to:
estimate a location of the user equipment using the at least one positioning measurement.

67. The apparatus of claim 64, wherein the at least one memory and computer program code configured to, with the at least one processor, cause the apparatus at least to:
based on the indication, transmit a request, to the user equipment or the network node, to report the positioning measurement with calibration.

68. The apparatus of claim 67, wherein the request comprises a request for calibrated measurements for one or more uplink and/or downlink reference signal resources considering an association between specific timing error groups and the reference signal resources.

69. The apparatus of claim 64, wherein the indication comprises an indication of whether the reference signal time difference measurement for downlink time difference of arrival has been calibrated for at least one of a specific user equipment receive timing error group or a specific transmission and reception point transmit timing error group.

70. The apparatus of claim 64, wherein the indication comprises an indication of a specific timing error group that was used as a baseline timing error group.

71. The apparatus of claim 64, wherein the indication comprises an indication of whether one or more receive-transmit time difference measurements for multi-cell round trip time have been calibrated for specific receive-transmit timing error groups.

72. The apparatus of claim 64, wherein the indication comprises an indication that the user equipment or the network node will report the calibrated measurements for specific timing error groups.

73. The apparatus of claim 64, wherein the apparatus comprises a location management function.

74. A method, comprising:
obtaining calibration information of a positioning measurement; and
transmitting, by a user equipment or network node, the positioning measurement and the calibration information to another network node, wherein the calibration information comprises an indication of whether the positioning measurement was calibrated.

75. The method of claim 74, wherein the indication comprises an indication of whether the reference signal time difference measurement for downlink time difference of arrival has been calibrated for at least one of a specific user equipment receive timing error group or a specific transmission and reception point transmit timing error group.
